(19) United States
(12) Patent Application Publication
(10) Pub. No.: US 2018/0357998 A1
(43) Pub. Date: Dec. 13, 2018

(54) WAKE-ON-VOICE KEYWORD DETECTION WITH INTEGRATED LANGUAGE IDENTIFICATION

(71) Applicant: INTEL IP CORPORATION, Santa Clara, CA (US)

(72) Inventors: Munir Nikolai Alexander Georges, Kehl (DE); Tobias Bocklet, Munich (DE)

(73) Assignee: INTEL IP CORPORATION, Santa Clara, CA (US)

(21) Appl. No.: 15/621,029

(22) Filed: Jun. 13, 2017

(51) Int. Cl. G10L 15/00; G10L 15/02; G10L 15/183; G10L 15/14; G10L 15/22

(52) U.S. Cl. CPC G10L 15/005; G10L 15/02; G10L 15/183; G10L 2015/088; G10L 15/22; G10L 2015/025; G10L 15/14

(57) ABSTRACT

Techniques are provided for language identification performed in conjunction with wake-on-voice keyword detection. A methodology implementing the techniques according to an embodiment includes applying phrase models to a user-spoken keyword. Each of the phrase models is configured to detect the keyword in a selected language and to generate a probability associated with the detection. The method further includes scoring the probabilities associated with the keyword detection in each of the languages, and identifying the language of the keyword based on the scoring. Automatic speech recognition and spoken language understanding systems may then be configured or selected to process further speech from the user in the identified language. In some embodiments, the phrase models are generated, in an offline process, based on provided grapheme sequences representing the keyword in the language associated with the phrase model. The graphemes are transcribed to phonemes for analysis by a language dependent acoustic model.

### BACKGROUND

Some computer systems or platforms become active or “wake-up” in response to the detection of a keyword or key-phrase spoken by the user. After wake-up, the computer proceeds to recognize and process the additional user speech that follows the keyword. Such systems employ speech recognition techniques and are typically pre-configured to operate in a selected language or dialect. If a new user, or a current user, wishes to speak in a different language, the system needs to be reconfigured. The reconfiguration process generally requires the user to select a desired language from a list of supported languages, which creates a disruption in the user's interactive experience and adversely impacts the quality of that experience. The subsequent reconfiguration process can also introduce additional latency. This can be particularly problematic for systems and devices intended for multiple users, such as home automation systems, personal assistants, and robotic applications. Additionally, this reconfiguration process can impose restrictions on the design of the user interface, for example requiring a more complex graphical user interface.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts.

FIG. 1 is a top-level block diagram of a speech enabled computer system with wake-on-voice (WOV) language identification, configured in accordance with certain embodiments of the present disclosure.

FIG. 2 is a more detailed block diagram of the WOV keyword detection and language identification system, configured in accordance with certain embodiments of the present disclosure.

FIG. 3 is a more detailed block diagram of a phrase model generation circuit, configured in accordance with certain embodiments of the present disclosure.

FIG. 4 is a block diagram illustrating another implementation of the speech enabled computer system with wake-on-voice (WOV) language identification, configured in accordance with certain embodiments of the present disclosure.

FIG. 5 is a flowchart illustrating a methodology for WOV language identification, in accordance with certain embodiments of the present disclosure.

FIG. 6 is a block diagram schematically illustrating a computing platform configured to perform WOV language identification, in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

Generally, this disclosure provides techniques for wake-on-voice keyword detection with integrated language identification. Wake-on-voice (WOV) keyword detection enables a computer system to remain in a low-power or sleep state when not in active use, while utilizing a relatively small portion of the available computing resources to listen for a wake-up keyword or key-phrase. The disclosed techniques enable WOV keyword detection to be performed simultaneously in multiple languages, dialects, or accents, such that a successful keyword detection also identifies the language spoken by the user. The resulting language ID may then be used to configure or select an automatic speech recognition (ASR) system and spoken language understanding (SLU) system to process further speech from the user in that language, in a manner that is transparent to the user. Said differently, the disclosed techniques enable the system to dynamically switch between different languages depending on the user's choice of language when uttering the wake-up keyword. It will be appreciated that the disclosed techniques may be used in conjunction with any type of speech processing system where knowledge of the spoken language can improve the functionality of the system. Such systems may include, for example, speaker verification and emotion recognition systems in addition to ASR and SLU systems.

The disclosed techniques can be implemented, for example, in a computing system or a software product executable or otherwise controllable by such systems, although other embodiments will be apparent. The system or product is configured to identify the language of a user during detection of a WOV keyword. In accordance with an embodiment, a methodology to implement these techniques includes applying phrase models to a user-spoken keyword. Each of the phrase models is configured to detect the keyword in a selected language and to generate a probability associated with the detection. The probability is a measure that the given phrase is in a particular language. The method further includes scoring or otherwise ranking the probabilities associated with the keyword detection in each of the languages, and identifying the language of the keyword based on the scoring (e.g., the language having the highest score or rank can be selected). ASR and SLU systems may then be configured or selected to process further speech from the user in the identified language. In some embodiments, the phrase models are pre-generated in an offline process based on grapheme sequences provided for this purpose. The sequences may be provided, for example, by the user at set-up time (out-of-box experience) or at the factory (pre-installed). The grapheme sequences represent the keyword in the language associated with the phrase model and are user/speaker independent. The graphemes are transcribed to phonemes for analysis by a language dependent acoustic model, the analysis used to generate the phrase model for the associated language, as will be described in greater detail below.

As will be appreciated, the techniques described herein allow for multiple users, speaking in different languages, to wake up the computer system and then interact with that system through a verbal dialog in their chosen language. This provides an improved quality of experience compared to existing methods that require the user to pre-select a language through a nonverbal or haptic interface (e.g., a touchscreen) prior to using the system. The disclosed techniques can be implemented on a broad range of platforms including laptops, tablets, smart phones, workstations, and embedded systems or devices. These techniques may further be implemented in hardware or software or a combination thereof. Multi-lingual households, offices, and customer service kiosks are a few of the venues where the systems provided herein may offer benefit.

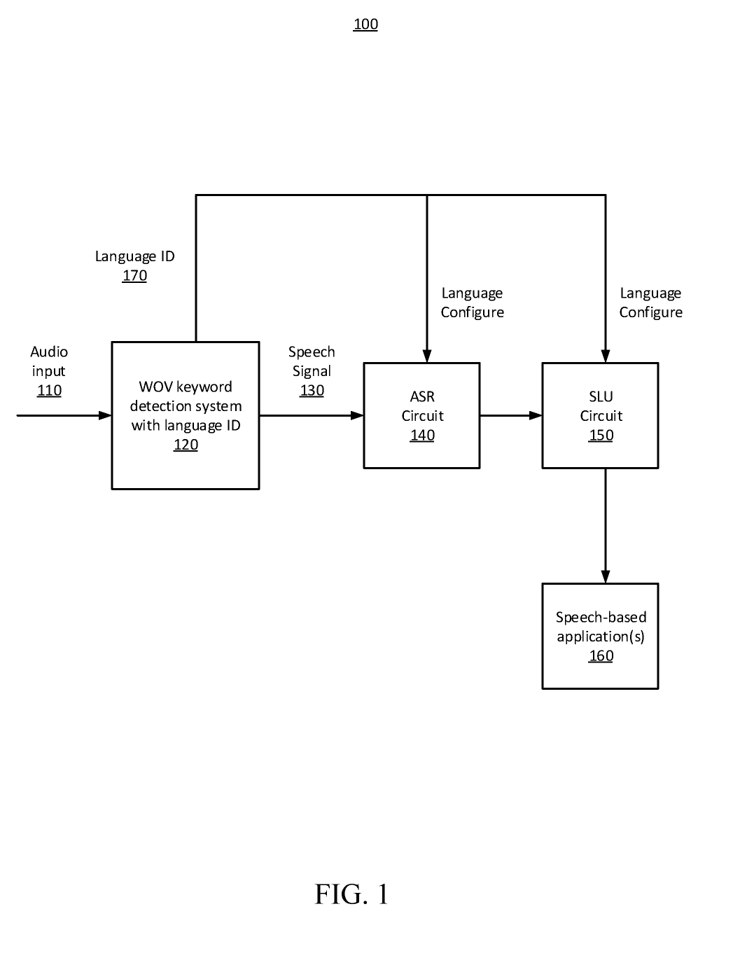

FIG. 1 is a top-level block diagram of a speech enabled computer system or platform 100 with wake-on-voice (WOV) language identification, configured in accordance with certain embodiments of the present disclosure. The computer system 100 is shown to include a WOV keyword detection system with language ID 120, an ASR circuit 140, an SLU circuit 150, and one or more speech-based applications 160.

At a high level, the detection system 120 is configured to listen for audio input 110 (for example, when the computer system is in a sleep or low-power state), and to detect a user-spoken wake-up keyword. The audio input 110 may be provided by a microphone, an array of microphones (e.g., configured for beamforming), or other suitable audio capture device. The keyword may be any one of a number of predetermined keywords or phrases chosen to wake up the computer system, such as, for example “hello computer.” The keyword may be spoken by the user in any of a number of languages (or dialects or accents), for which the detection system 120 is preconfigured. The detection system 120 simultaneously detects the keyword and identifies the language (e.g., English, Spanish, French, German, Mandarin, etc.).

The resulting language ID 170 is provided to the ASR circuit 140 and the SLU circuit 150 to enable them to process the speech signal 130 associated with further speech by the user. When appropriately configured for the correct language, the ASR circuit 140 recognizes the words of the user's speech and the SLU circuit 150 determines an understanding of the meaning of the user's speech. That understanding may then be provided to one or more speech-based applications 160, configured to act on that speech. Some examples of speech-based applications include automobile navigation systems, smart-home management systems, personal assistants, and robots. In some embodiments, a ranking of two or more identified language possibilities associated with the keyword may be provided to the ASR and SLU based on the scoring.

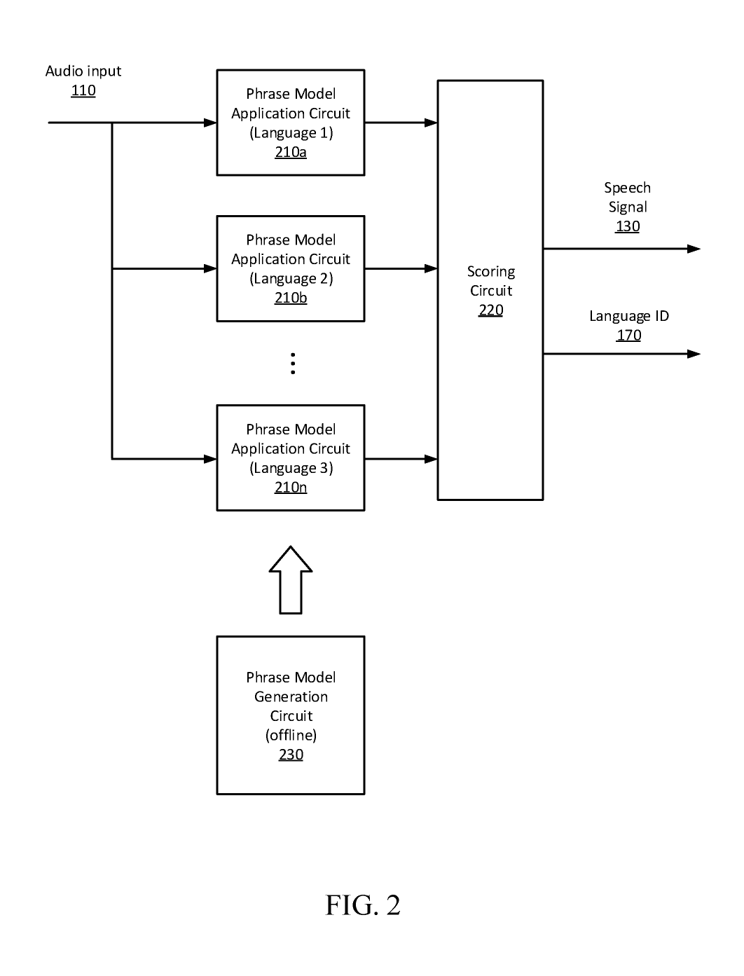

FIG. 2 is a more detailed block diagram of the WOV keyword detection and language identification system 120, configured in accordance with certain embodiments of the present disclosure. The WOV keyword detection and language identification system 120 is shown to include a phrase model generation circuit 230, phrase model application circuits 210a, 210b, 210n (e.g., one for each of N languages), and a scoring circuit 220. The number of languages, dialects, or accents is not limited.

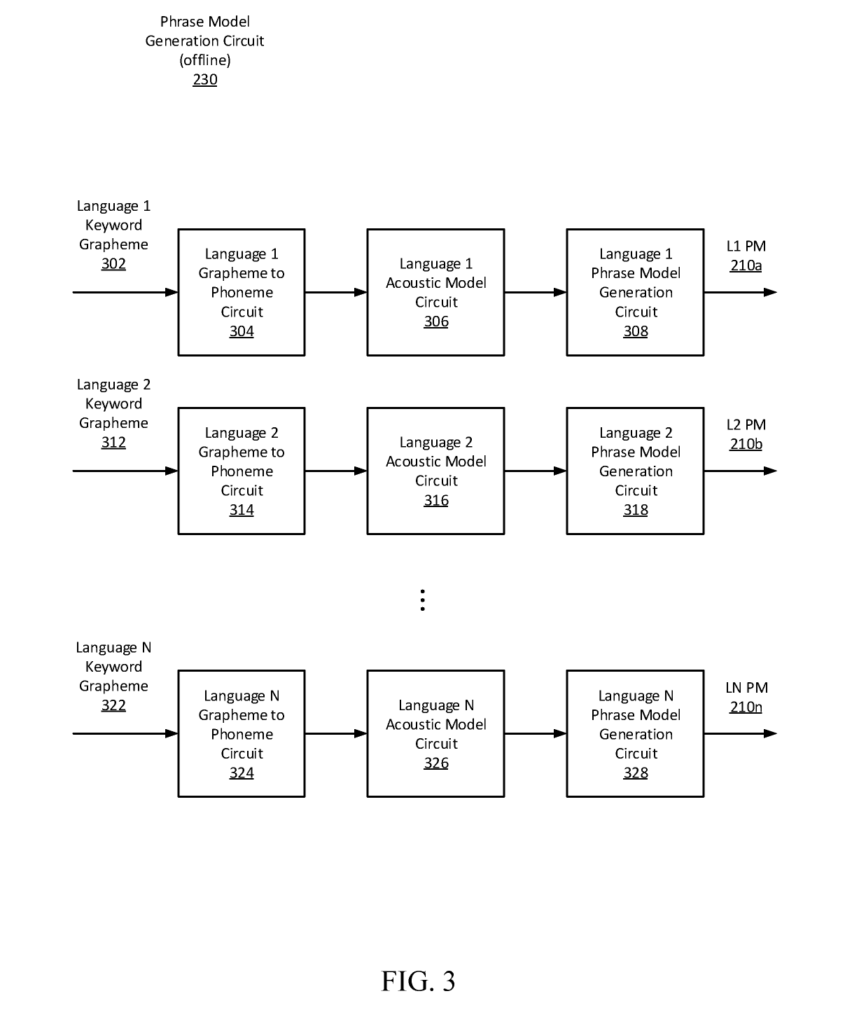

The phrase model generation circuit 230 is configured to pre-generate the phrase models 210a, 210b, 210n for each language as a one-time offline process (e.g., an initialization that can be performed prior to the real-time keyword detection). The operation of the phrase model generation circuit 230 is described in greater detail below, in connection with FIG. 3.

The phrase model application circuits 210a, 210b, 210n are configured to apply the pre-generated phrase models to a user-spoken keyword of the audio input 110. Each of the phrase models are configured to detect the keyword (or keywords) in a language associated with that phrase model and to generate a hypothesis probability associated with the detection, using known techniques in light of the present disclosure. For example, if the keyword “hello computer” is spoken in English, the English phrase model may generate a probability closer to 100 percent, while the Mandarin phrase model may generate a probability closer to zero percent. In some embodiments, each of the phrase models may be applied to the audio input in parallel for improved efficiency.

The scoring circuit 220 is configured to score or otherwise rank the probabilities associated with the keyword detection in each of the languages (or dialects or accents), and to identify the language of the keyword based on the scoring. For example, all recognized phrase hypotheses are scored against each other to determine the most probable phrase given the most probable language. Note that the score provided by the scoring circuit 220 may be configured to rank the outputs provided from each of the phrase model application circuits 210(a-n), such that the output having the highest rank can be readily identified. In some embodiments, the identified language 170 may be associated with the highest phrase model score.

The resulting language ID 170 is provided to the ASR 140 and/or SLU 150 for configuration to the identified language. The speech signal 130 (and/or audio features extracted from the speech signal) is also provided to the ASR/SLU for further processing in the identified language. The keyword detection may also be used to trigger the ASR/SLU to transition or wake from a lower power consuming sleep state to a higher power consuming processing state. In some embodiments, the WOV keyword detection and language ID may be performed on a digital signal processor (DSP) or other relatively low power consuming CPU. In some embodiments, the phrase model application circuits 210a, 210b, 210n and scoring circuit 220 may be hosted on a wearable device.

FIG. 3 is a more detailed block diagram of a phrase model generation circuit 230, configured in accordance with certain embodiments of the present disclosure. The phrase model generation circuit 230 is shown to include a processing pipeline for each of N languages. Each pipeline includes a grapheme to phoneme transcription circuit 304, 314, 324, an acoustic model circuit 306, 316, 326, and a phrase model generation circuit 308, 318, 328.

The grapheme to phoneme transcription circuits 304, 314, 324 are configured to accept a sequence of graphemes that represent the keyword in the associated language 302, 312, 322, and transcribe them to phonemes. A grapheme is a speaker independent symbol that generally represents the smallest unit of a writing system in a given language, such as an alphabetic character, Chinese character, digit, punctuation mark, etc. For example, the grapheme for the phrase “hello computer” in English is the sequence of text characters
h e l l o space c o m p u t e r,
   while the grapheme for the same phrase in Mandarin is [symbol]
   Phonemes generally represent the smallest units of sound that distinguish words in each language. The grapheme to phoneme transcription process may be performed using known techniques in light of the present disclosure, such as, for example, lexicon lookup for known words or use of G2P models.

The acoustic model circuits 306, 316, 326 are configured to analyze the transcribed phonemes based on the application of a language dependent acoustic model to the transcribed phonemes. The phrase model generation circuits 308, 318, 328 are configured to generate the phrase models for each language L1 PM 210a, L2 PM 210b, LN PM 210n, based on the acoustic model analysis, using known techniques in light of the present disclosure. This process may of course be repeated any number of times to allow for the recognition of any desired number of WOV keywords in each language.

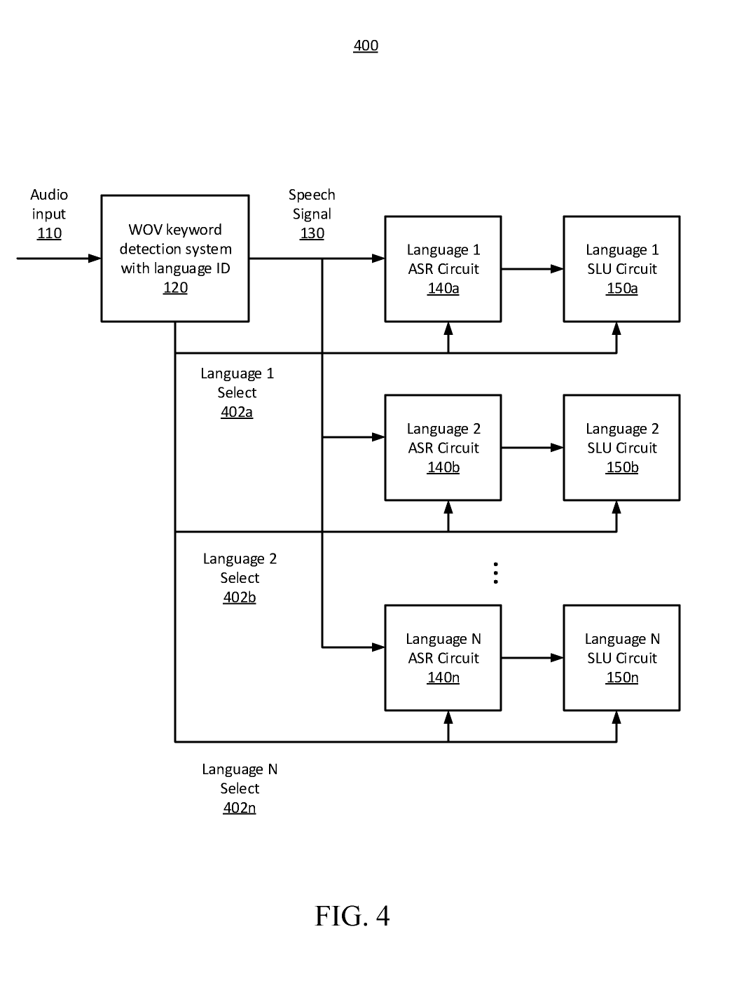

FIG. 4 is a block diagram illustrating another implementation 400 of the speech enabled computer system with wake-on-voice (WOV) language identification, configured in accordance with certain embodiments of the present disclosure. In this embodiment, a number of ASR circuits 140a, 140b, 140n and SLU circuits 150a, 150b, 150n are each preconfigured for different languages (or dialects or accents), 1 through N. The WOV keyword detection and language identification system 120 is configured to select the appropriate ASR/SLU combination based on the identified language, for example with one of the language selection signals 402a, 402b, 402n. The speech signal 130 is provided to the selected ASR/SLU combination for processing of further speech from the user.

Methodology

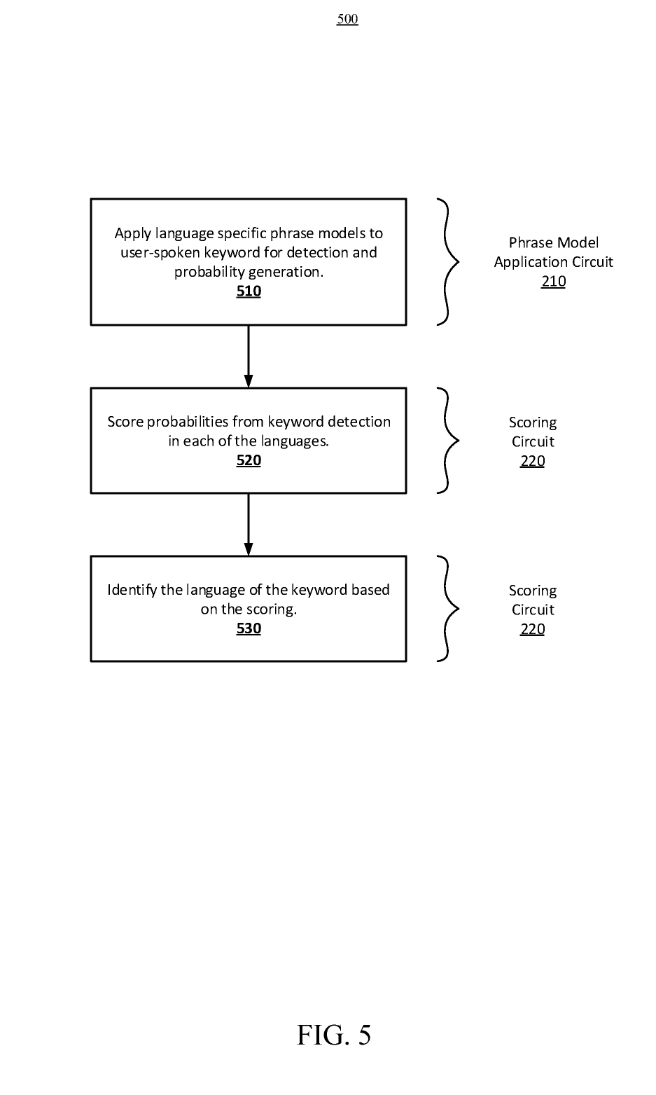

FIG. 5 is a flowchart illustrating an example method 500 for WOV keyword detection with integrated language identification, in accordance with certain embodiments of the present disclosure. As can be seen, the example method includes a number of phases and sub-processes, the sequence of which may vary from one embodiment to another. However, when considered in the aggregate, these phases and sub-processes form a process for language identification in accordance with certain of the embodiments disclosed herein. These embodiments can be implemented, for example using the system architecture illustrated in FIGS. 1-4 as described above. However other system architectures can be used in other embodiments, as will be apparent in light of this disclosure. To this end, the correlation of the various functions shown in FIG. 5 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 500. Thus, other embodiments may have fewer or more modules and/or sub-modules depending on the granularity of implementation. In still other embodiments, the methodology depicted can be implemented as a computer program product including one or more non-transitory machine readable mediums that when executed by one or more processors cause the methodology to be carried out. Numerous variations and alternative configurations will be apparent in light of this disclosure.

As illustrated in FIG. 5, in an embodiment, method 500 for WOV language identification commences by applying, at operation 510, language specific phrase models to a user-spoken keyword. Each of the phrase models is configured to detect the keyword in a language associated with that phrase model and to generate a probability associated with the detection. In some embodiments, any number of phrase models may be employed to allow for operation in any desired number of languages, dialects or accents. The phrase models may be applied to the user-spoken keyword in parallel for improved efficiency.

Next, at operation 520, the probabilities associated with the keyword detection in each of the languages are scored. At operation 530, the language of the user-spoken keyword is identified based on the scoring. In some embodiments, a ranking of identified languages associated with the keyword may be provided based on the scoring.

Of course, in some embodiments, additional operations may be performed, as previously described in connection with the system. For example, an automatic speech recognition (ASR) circuit and/or a spoken language understanding (SLU) circuit may be configured or selected to operate on the language identified from the keyword so that further speech from the user is processed in the identified language. In some embodiments, the phrase models are generated based on provided grapheme sequences representing the keyword in the language associated with the phrase model. The graphemes are transcribed to phonemes for analysis by a language dependent acoustic model. The phrase model generation may be performed in an off-line process, for example, prior to the real-time operation of the WOV language identification process.

Example System

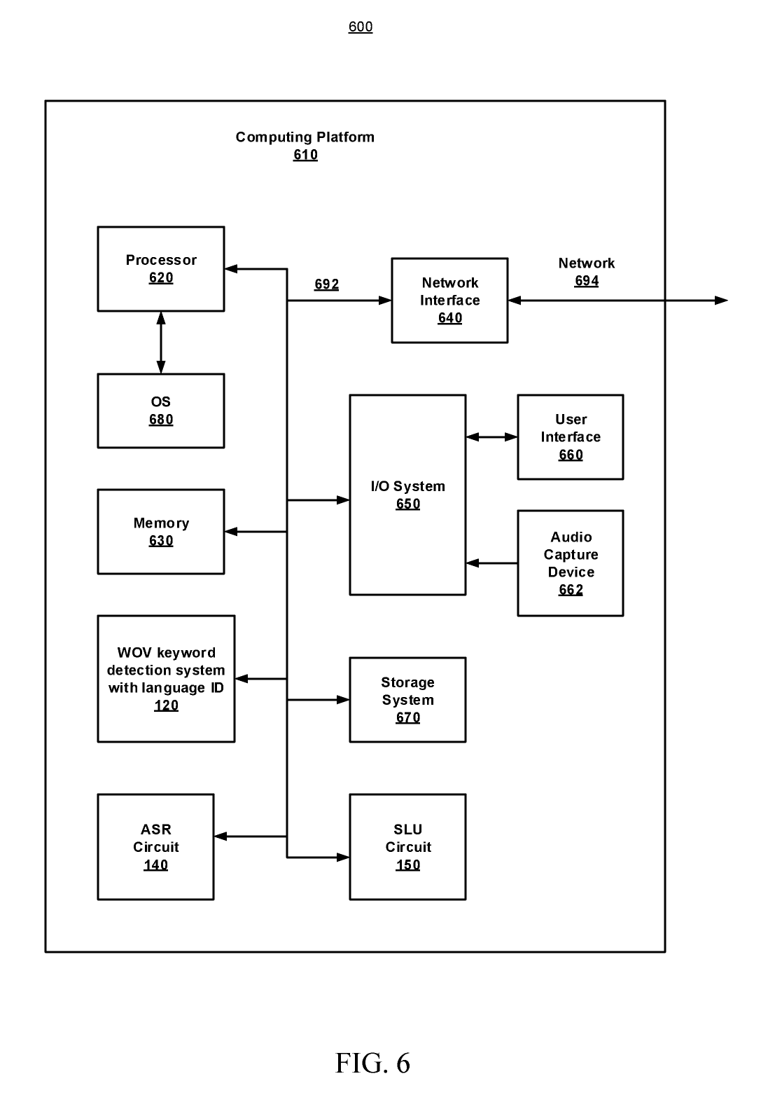

FIG. 6 illustrates an example system 600 to perform WOV keyword detection with integrated language identification, configured in accordance with certain embodiments of the present disclosure. In some embodiments, system 600 comprises a computing platform 610 which may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, wearable device, embedded system, and so forth. Any combination of different devices may be used in certain embodiments.

In some embodiments, platform 610 may comprise any combination of a processor 620, a memory 630, WOV keyword detection system with language ID 120, ASR circuit 140, SLU circuit 150, a network interface 640, an input/output (I/O) system 650, a user interface 660, an audio capture device 662, and a storage system 670. As can be further seen, a bus and/or interconnect 692 is also provided to allow for communication between the various components listed above and/or other components not shown. Platform 610 can be coupled to a network 694 through network interface 640 to allow for communications with other computing devices, platforms, or resources. Other componentry and functionality not reflected in the block diagram of FIG. 6 will be apparent in light of this disclosure, and it will be appreciated that other embodiments are not limited to any particular hardware configuration.

Processor 620 can be any suitable processor, and may include one or more coprocessors or controllers, such as an audio processor, a graphics processing unit, or hardware accelerator, to assist in control and processing operations associated with system 600. In some embodiments, the processor 620 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 620 may be implemented as a complex instruction set computer (CISC) or a reduced instruction set computer (RISC) processor. In some embodiments, processor 620 may be configured as an x86 instruction set compatible processor.

Memory 630 can be implemented using any suitable type of digital storage including, for example, flash memory and/or random access memory (RAM). In some embodiments, the memory 630 may include various layers of memory hierarchy and/or memory caches as are known to those of skill in the art. Memory 630 may be implemented as a volatile memory device such as, but not limited to, a RAM, dynamic RAM (DRAM), or static RAM (SRAM) device. Storage system 670 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 670 may comprise technology to increase the storage performance enhanced protection for valuable digital media when multiple hard drives are included.

In some embodiments, the language phrase models and language acoustic models may be stored in separate blocks or regions of memory.

Processor 620 may be configured to execute an Operating System (OS) 680 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with system 600, and therefore may also be implemented using any suitable existing or subsequently-developed platform.

Network interface circuit 640 can be any appropriate network chip or chipset which allows for wired and/or wireless connection between other components of computer system 600 and/or network 694, thereby enabling system 600 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 650 may be configured to interface between various I/O devices and other components of computer system 600. I/O devices may include, but not be limited to, user interface 660 and audio capture device 662 (e.g., a microphone). User interface 660 may include devices (not shown) such as a display element, touchpad, keyboard, mouse, and speaker, etc. I/O system 650 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 620 or any chipset of platform 610.

It will be appreciated that in some embodiments, the various components of the system 600 may be combined or integrated in a system-on-a-chip (SoC) architecture. In some embodiments, the components may be hardware components, firmware components, software components or any suitable combination of hardware, firmware or software.

WOV keyword detection system with language ID 120 is configured to perform language identification based on detected user-spoken WOV keyword, as described previously. WOV keyword detection system with language ID 120 may include any or all of the circuits/components illustrated in FIGS. 1-4, as described above. These components can be implemented or otherwise used in conjunction with a variety of suitable software and/or hardware that is coupled to or that otherwise forms a part of platform 610. These components can additionally or alternatively be implemented or otherwise used in conjunction with user I/O devices that are capable of providing information to, and receiving information and commands from, a user.

In some embodiments, these circuits may be installed local to system 600, as shown in the example embodiment of FIG. 6. Alternatively, system 600 can be implemented in a client-server arrangement wherein at least some functionality associated with these circuits is provided to system 600 using an applet, such as a JavaScript applet, or other downloadable module or set of sub-modules. Such remotely accessible modules or sub-modules can be provisioned in real-time, in response to a request from a client computing system for access to a given server having resources that are of interest to the user of the client computing system. In such embodiments, the server can be local to network 694 or remotely coupled to network 694 by one or more other networks and/or communication channels. In some cases, access to resources on a given network or computing system may require credentials such as usernames, passwords, and/or compliance with any other suitable security mechanism.

In various embodiments, system 600 may be implemented as a wireless system, a wired system, or a combination of both. When implemented as a wireless system, system 600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, system 600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the language identification methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 694. In other embodiments, the functionalities disclosed herein can be incorporated into other speech-based software applications, such as, for example, automobile control/navigation, smart-home management, entertainment, and robotic applications. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments system 600 may comprise additional, fewer, or alternative subcomponents as compared to those included in the example embodiment of FIG. 6.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a processor-implemented method for language identification. The method comprises: applying, by a processor-based system, each of a plurality of phrase models to a user-spoken keyword, each of the phrase models configured to detect the keyword in a language associated with the phrase model and to generate a probability associated with the detection; scoring, by the processor-based system, the probabilities associated with the keyword detection in each of the languages; and identifying, by the processor-based system, the language of the keyword based on the scoring.

Example 2 includes the subject matter of Example 1, further comprising configuring an automatic speech recognition (ASR) circuit and a spoken language understanding (SLU) circuit to operate on the identified language of the keyword.

Example 3 includes the subject matter of Examples 1 or 2, further comprising selecting an automatic speech recognition (ASR) circuit and a spoken language understanding (SLU) circuit configured to operate on the identified language of the keyword.

Example 4 includes the subject matter of any of Examples 1-3, further comprising generating the plurality of phrase models, the generation including: receiving a sequence of graphemes representing the keyword in the language associated with the phrase model to be generated; transcribing the graphemes to phonemes; analyzing the transcribed phonemes based on application of a language dependent acoustic model; and generating the phrase model based on the analysis.

Example 5 includes the subject matter of any of Examples 1-4, wherein the language identification is performed in real-time and the phrase model generation is performed as an offline initialization process.

Example 6 includes the subject matter of any of Examples 1-5, further comprising waking an ASR circuit and an SLU circuit from a lower power consuming sleep state to a higher power consuming processing state, based on the detection of the keyword.

Example 7 includes the subject matter of any of Examples 1-6, further comprising providing results generated by the SLU circuit to a speech-based application configured to perform an action based on the SLU results.

Example 8 includes the subject matter of any of Examples 1-7, further comprising applying the plurality of phrase models to the user-spoken keyword in parallel.

Example 9 is a system for language identification. The system comprises: a phrase model application circuit to apply each of a plurality of phrase models to a user-spoken keyword, each of the phrase models configured to detect the keyword in a language associated with the phrase model and to generate a probability associated with the detection; and a scoring circuit to score the probabilities associated with the keyword detection in each of the languages and to provide a ranking of identified languages of the keyword based on the scoring.

Example 10 includes the subject matter of Example 9, wherein the identified language of the keyword is used to configure an automatic speech recognition (ASR) circuit and a spoken language understanding (SLU) circuit for operation on the identified language.

Example 11 includes the subject matter of Examples 9 or 10, wherein the identified language of the keyword is used to select an automatic speech recognition (ASR) circuit and a spoken language understanding (SLU) circuit for operation on the identified language.

Example 12 includes the subject matter of any of Examples 9-11, further comprising a phrase model generation circuit to: receive a sequence of graphemes representing the keyword in the language associated with the phrase model to be generated; transcribe the graphemes to phonemes; analyze the transcribed phonemes based on application of a language dependent acoustic model; and generate the phrase model based on the analysis.

Example 13 includes the subject matter of any of Examples 9-12, wherein the language identification is performed in real-time and the phrase model generation is performed as an offline initialization process.

Example 14 includes the subject matter of any of Examples 9-13, wherein the detection of the keyword triggers a waking of an ASR circuit and an SLU circuit from a lower power consuming sleep state to a higher power consuming processing state.

Example 15 includes the subject matter of any of Examples 9-14, wherein the phrase model application circuit is further to apply the plurality of phrase models to the user-spoken keyword in parallel.

Example 16 includes the subject matter of any of Examples 9-15, wherein the system is implemented on a digital signal processor (DSP) operating at a lower power consumption relative to a general-purpose processor.

Example 17 includes the subject matter of any of Examples 9-16, wherein the phrase model application circuit and the scoring circuit are hosted on a wearable device.

Example 18 is at least one non-transitory computer readable storage medium having instructions encoded thereon that, when executed by one or more processors, result in the following operations for language identification. The operations comprise: applying each of a plurality of phrase models to a user-spoken keyword, each of the phrase models configured to detect the keyword in a language associated with the phrase model and to generate a probability associated with the detection; scoring the probabilities associated with the keyword detection in each of the languages; and identifying the language of the keyword based on the scoring.

Example 19 includes the subject matter of Example 18, the operations further comprising configuring an automatic speech recognition (ASR) circuit and a spoken language understanding (SLU) circuit to operate on the identified language of the keyword.

Example 20 includes the subject matter of Examples 18 or 19, the operations further comprising selecting an automatic speech recognition (ASR) circuit and a spoken language understanding (SLU) circuit configured to operate on the identified language of the keyword.

Example 21 includes the subject matter of any of Examples 18-20, the operations further comprising generating the plurality of phrase models, the generation including: receiving a sequence of graphemes representing the keyword in the language associated with the phrase model to be generated; transcribing the graphemes to phonemes; analyzing the transcribed phonemes based on application of a language dependent acoustic model; and generating the phrase model based on the analysis.

Example 22 includes the subject matter of any of Examples 18-21, wherein the language identification is performed in real-time and the phrase model generation is performed as an offline initialization process.

Example 23 includes the subject matter of any of Examples 18-22, the operations further comprising waking an ASR circuit and an SLU circuit from a lower power consuming sleep state to a higher power consuming processing state, based on the detection of the keyword.

Example 24 includes the subject matter of any of Examples 18-23, the operations further comprising providing results generated by the SLU circuit to a speech-based application configured to perform an action based on the SLU results.

Example 25 includes the subject matter of any of Examples 18-24, the operations further comprising applying the plurality of phrase models to the user-spoken keyword in parallel.

Example 26 is a system for language identification. The system comprises: means for applying each of a plurality of phrase models to a user-spoken keyword, each of the phrase models configured to detect the keyword in a language associated with the phrase model and to generate a probability associated with the detection; means for scoring the probabilities associated with the keyword detection in each of the languages; and means for identifying the language of the keyword based on the scoring.

Example 27 includes the subject matter of Example 26, further comprising means for configuring an automatic speech recognition (ASR) circuit and a spoken language understanding (SLU) circuit to operate on the identified language of the keyword.

Example 28 includes the subject matter of Examples 26 or 27, further comprising means for selecting an automatic speech recognition (ASR) circuit and a spoken language understanding (SLU) circuit configured to operate on the identified language of the keyword.

Example 29 includes the subject matter of any of Examples 26-28, further comprising means for generating the plurality of phrase models, the means for generating including: means for receiving a sequence of graphemes representing the keyword in the language associated with the phrase model to be generated; means for transcribing the graphemes to phonemes; means for analyzing the transcribed phonemes based on application of a language dependent acoustic model; and means for generating the phrase model based on the analysis.

Example 30 includes the subject matter of any of Examples 26-29, wherein the language identification is performed in real-time and the phrase model generation is performed as an offline initialization process.

Example 31 includes the subject matter of any of Examples 26-30, further comprising means for waking an ASR circuit and an SLU circuit from a lower power consuming sleep state to a higher power consuming processing state, based on the detection of the keyword.

Example 32 includes the subject matter of any of Examples 26-31, further comprising means for providing results generated by the SLU circuit to a speech-based application configured to perform an action based on the SLU results.

Example 33 includes the subject matter of any of Examples 26-32, further comprising means for applying the plurality of phrase models to the user-spoken keyword in parallel.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. A processor-implemented method for language identification, the method comprising:
applying, by a processor-based system, each of a plurality of phrase models to a user-spoken keyword, each of the phrase models configured to detect the keyword in a language associated with the phrase model and to generate a probability associated with the detection;
scoring, by the processor-based system, the probabilities associated with the keyword detection in each of the languages; and
identifying, by the processor-based system, the language of the keyword based on the scoring.

2. The method of claim 1, further comprising configuring an automatic speech recognition (ASR) circuit and a spoken language understanding (SLU) circuit to operate on the identified language of the keyword.

3. The method of claim 1, further comprising selecting an automatic speech recognition (ASR) circuit and a spoken language understanding (SLU) circuit configured to operate on the identified language of the keyword.

4. The method of claim 1, further comprising generating the plurality of phrase models, the generation including:
receiving a sequence of graphemes representing the keyword in the language associated with the phrase model to be generated;
transcribing the graphemes to phonemes;
analyzing the transcribed phonemes based on application of a language dependent acoustic model; and
generating the phrase model based on the analysis.

5. The method of claim 4, wherein the language identification is performed in real-time and the phrase model generation is performed as an offline initialization process.

6. The method of claim 1, further comprising waking an ASR circuit and an SLU circuit from a lower power consuming sleep state to a higher power consuming processing state, based on the detection of the keyword.

7. The method of claim 6, further comprising providing results generated by the SLU circuit to a speech-based application configured to perform an action based on the SLU results.

8. The method of claim 1, further comprising applying the plurality of phrase models to the user-spoken keyword in parallel.

9. A system for language identification, the system comprising:
a phrase model application circuit to apply each of a plurality of phrase models to a user-spoken keyword, each of the phrase models configured to detect the keyword in a language associated with the phrase model and to generate a probability associated with the detection; and
a scoring circuit to score the probabilities associated with the keyword detection in each of the languages and to provide a ranking of identified languages of the keyword based on the scoring.

10. The system of claim 9, wherein the identified language of the keyword is used to configure an automatic speech recognition (ASR) circuit and a spoken language understanding (SLU) circuit for operation on the identified language.

11. The system of claim 9, wherein the identified language of the keyword is used to select an automatic speech recognition (ASR) circuit and a spoken language understanding (SLU) circuit for operation on the identified language.

12. The system of claim 9, further comprising a phrase model generation circuit to:
receive a sequence of graphemes representing the keyword in the language associated with the phrase model to be generated;
transcribe the graphemes to phonemes;
analyze the transcribed phonemes based on application of a language dependent acoustic model; and
generate the phrase model based on the analysis.

13. The system of claim 12, wherein the language identification is performed in real-time and the phrase model generation is performed as an offline initialization process.

14. The system of claim 9, wherein the detection of the keyword triggers a waking of an ASR circuit and an SLU circuit from a lower power consuming sleep state to a higher power consuming processing state.

15. The system of claim 9, wherein the phrase model application circuit is further to apply the plurality of phrase models to the user-spoken keyword in parallel.

16. The system of claim 9, wherein the system is implemented on a digital signal processor (DSP) operating at a lower power consumption relative to a general-purpose processor.

17. The system of claim 9, wherein the phrase model application circuit and the scoring circuit are hosted on a wearable device.

18. At least one non-transitory computer readable storage medium having instructions encoded thereon that, when executed by one or more processors, result in the following operations for language identification, the operations comprising:
applying each of a plurality of phrase models to a user-spoken keyword, each of the phrase models configured to detect the keyword in a language associated with the phrase model and to generate a probability associated with the detection;
scoring the probabilities associated with the keyword detection in each of the languages; and
identifying the language of the keyword based on the scoring.

19. The computer readable storage medium of claim 18, the operations further comprising configuring an automatic speech recognition (ASR) circuit and a spoken language understanding (SLU) circuit to operate on the identified language of the keyword.

20. The computer readable storage medium of claim 18, the operations further comprising selecting an automatic speech recognition (ASR) circuit and a spoken language understanding (SLU) circuit configured to operate on the identified language of the keyword.

21. The computer readable storage medium of claim 18, the operations further comprising generating the plurality of phrase models, the generation including:
receiving a sequence of graphemes representing the keyword in the language associated with the phrase model to be generated;
transcribing the graphemes to phonemes;
analyzing the transcribed phonemes based on application of a language dependent acoustic model; and
generating the phrase model based on the analysis.

22. The computer readable storage medium of claim 21, wherein the language identification is performed in real-time and the phrase model generation is performed as an offline initialization process.

23. The computer readable storage medium of claim 18, the operations further comprising waking an ASR circuit and an SLU circuit from a lower power consuming sleep state to a higher power consuming processing state, based on the detection of the keyword.

24. The computer readable storage medium of claim 23, the operations further comprising providing results generated by the SLU circuit to a speech-based application configured to perform an action based on the SLU results.

25. The computer readable storage medium of claim 18, the operations further comprising applying the plurality of phrase models to the user-spoken keyword in parallel.
